(19) United States
(12) Patent Application Publication
(10) Pub. No.: US 2008/0205664 A1
(43) Pub. Date: Aug. 28, 2008

(54) Multi-type audio processing system and method

(75) Inventors: Ju Yun Kim, Seoul (KR); Seung Jai Lee, Goyang-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/903,639

(22) Filed: Sep. 24, 2007

(30) Foreign Application Priority Data
Feb. 27, 2007 (KR) 2007-0019525

(51) Int. Cl. H04B 3/00

(52) U.S. Cl. 381/77

(57) ABSTRACT

A multi-type audio processing system and method that are capable of selectively processing mono and stereo audio signals for enhancing the ability of a user to listen sounds from a variety of sources associated with a mobile terminal, PDA, etc. A multi-type audio processing method for an audio system including an audio source device and a headset connected to the audio source device includes transmitting, at the headset, capability of the headset to the audio source device; transmitting, at the audio source device, a stereo audio stream to the headset on the basis of the capability; and playing, at the headset, the stereo audio stream received from the audio source device. The multi-type audio processing system and method of the present invention are advantageous in that a signal headset can process both stereo and mono audio streams, and the mobile terminal can provide transmission of signals according the capabilities of the headset.

### CLAIM OF PRIORITY

This application claims priority under 35 U.S.C. §119(a) from an application entitled “MULTI-TYPE AUDIO PROCESSING SYSTEM AND METHOD” filed in the Korean Intellectual Property Office on Feb. 27, 2007 and assigned Serial No. 2007-0019525, the contents of which are incorporated herein by reference in its entirety.

### BACKGROUND OF THE INVENTION

1. Field of the Invention

The present invention relates to an audio processing system and method. More particularly, the present invention relates to a multi-type audio processing system and method that are capable of selectively processing mono and stereo audio signals.

2. Description of the Related Art

The mobile phone is one of most rapidly evolving electronic devices in existence. Recent advances in mobile phones include the merger of a variety of functions, including but not limited to a Moving Picture Experts Group Layer-3 (MP3) player, a Digital Multimedia Broadcast (DMB) receiver, a motion picture player, and a digital camera while maintaining its portability, and in some cases, even reducing the size of the device despite adding capabilities not available in one unit. The integration of functions and capabilities is likely to continue for the foreseeable future.

Typically, a mobile phone is implemented with a speaker for outputting an audio signal produced with the supplementary functions in the form of audible sound wave. However, the speaker output may be noisy to other people and even intrude on other people's privacy. In fact, certain public places such as libraries, theaters, etc., often do not permit the use of a mobile telephone because of such concerns. For this reason, earphones or headsets have been used to prevent other people from hearing the sound either for privacy or to prevent disturbance.

In order to focus attention on voice communications, a mono earphone or mono headset is used. However, such mono earphone and headset are limited in outputting high quality sound. Accordingly, although a device connected to the earphone or headset provides high quality stereo audio, a user often just barely hears the sounds associated with voice communication due the limited output sound quality level of the earphone or headset. Also, the words in a conversation generally need to be listened to (or are listened to) more closely than music, and this reduced quality can lead to a misunderstanding between a user of a mobile telephone and the other party. When both users are conversing with mobile telephones in noisy environments, the problem is exacerbated.

### SUMMARY OF THE INVENTION

The present invention has been made in part in an effort to solve at least some of the above-mentioned problems. Therefore, one of the many objects of the present invention is to provide a multi-type audio processing system and method that enables a headset to selectively process mono and stereo audio received from an audio source device, and output the processed audio in various per-channel based output modes.

In accordance with an exemplary aspect of the present invention, the above and other objects are accomplished by providing a multi-type audio processing method for an audio system including an audio source device and a headset connected to the audio source device. The multi-type audio processing method includes transmitting by the headset, capability of the headset to the audio source device; transmitting by the audio source device, a stereo audio stream to the headset on the basis of the capability; and playing at the headset, the stereo audio stream received from the audio source device.

In accordance with another exemplary aspect of the present invention, the above and other objects are accomplished by providing a multi-type audio processing method for an audio system including a mobile phone and a headset connected to the mobile phone. The multi-type audio processing method includes transmitting by the headset, a mode selection signal informing a current operation mode of the headset to the mobile phone; transmitting by the mobile phone, an audio file supported by the operation mode; and playing at the headset, the audio file received from the mobile phone.

In accordance with another exemplary aspect of the present invention, the above and other objects are accomplished by providing a multi-type audio processing system. The multi-type audio processing system includes a mobile phone for generating an audio stream from an audio source and transmitting an audio stream; and a headset for playing the audio stream received from the mobile phone, the headset being connected with the mobile phone through a short range wireless communication channel, wherein the headset transmits a communication profile supported by the headset and a mode selection signal for indicating an operational mode of the headset to the mobile phone, the mobile phone transmits the audio stream in accordance with the communication profile and the mode selection signal, and the headset decodes the received audio stream and playing on the basis of the operational mode.

### BRIEF DESCRIPTION OF THE DRAWINGS

The above features and advantages of the present invention will be more apparent from the following detailed description in conjunction with the accompanying drawings, in which:

FIG. 1 is a schematic diagram illustrating a multi-type audio processing system according to an exemplary embodiment of the present invention;

FIG. 2 is a block diagram illustrating a configuration of the mobile phone 100 shown in FIG. 1;

FIG. 3 is a block diagram illustrating a configuration of the headset 200 shown in FIG. 1;

FIG. 4 is a flowchart illustrating the steps of a multi-type audio processing method according to an exemplary embodiment of the present invention;

FIG. 5 is a message flow diagram illustrating the multi-type audio processing method of FIG. 4;

FIG. 6 is a flowchart illustrating the steps of a multi-type audio processing method according to another exemplary embodiment of the present invention; and

FIG. 7 is a message flow diagram illustrating the multi-type audio processing method of FIG. 6.

### DETAILED DESCRIPTION OF THE INVENTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention with detailed descriptions of such known functions and structures.

Certain terminologies are used in the following description for convenience and reference only and are not limiting. Furthermore, the drawings and associated descriptions are provided for purposes of illustration and the present invention is not limited to the examples shown and described herein. In the following detailed description, only the exemplary embodiments of the invention shown and described, include the best mode contemplated by the inventor(s) of carrying out the invention. A person or ordinary skill in the art understands and appreciates that the invention is capable of modification in various respects, all without departing from the spirit of the invention and the scope of the appended claims. Accordingly, the drawings and description are to be regarded as illustrative in nature and not restrictive.

In the following embodiments, the multi-type audio processing system and method of the present invention are described with a mobile phone and a headset, each equipped with a Bluetooth chip. However, the present invention is not limited to the Bluetooth-equipped mobile phone and headset or an equivalent, as any known communication protocol can be used. For example, the multi-type audio processing system and method of the present invention can be implemented with mobile devices communicating with each other in another short range wireless technology, such as IEEE 802.11, Zigbee, Ultra Wide Band (UWB), IrDa, visible light communication (VLC) and/or other technologies and their equivalents.

Furthermore, although the multi-type audio processing system and method of the present invention is described with a headset, the present invention is not limited thereto. For example, the headset can be replaced by items such as a wireless earset, wireless speaker, earplug containing a transducer for sound, ear clip, eyeglass clipped speaker(s)/earpiece(s), or hearing aid, and their equivalents that can transduce the audio signal received from an audio source through a wireless channel and output the audio signal in the form of an audible sound wave.

In addition, in order to aid understanding the present invention, the general components of a headset are denoted as following. A headset includes a left earpiece for outputting a left channel of a stereo audio signal and a right earpiece for outputting right channel of the stereo audio signal. In the exemplary embodiments of the present invention, the left and right channels of the stereo audio can be selectively processed by the headset.

In the following embodiments, the multi-type audio processing system and method are described with a mobile phone. However, the present invention is not limited to the mobile phone. For example, the multi-type audio processing system and method can be implemented with an information processing device supporting a transmission of stereo audio through a short range wireless communication channel. The information processing device includes a Personal Digital Assistant (PDA), a laptop computer, a Smartphone, a 3^{rd} generation standard mobile terminal, a Code Division Multiple Access (CDMA) terminal, a Global System for mobile communication (GSM) terminal, a portable device with communication capability, a Global Packet Radio Services (GPRS) terminal, a Wireless Local Area Network (WLAN) terminal, a Wireless Broadband (WiBro) Terminal, and a High Speed Downlink Packet Access (HSDPA) terminal, just to name a few of such devices.

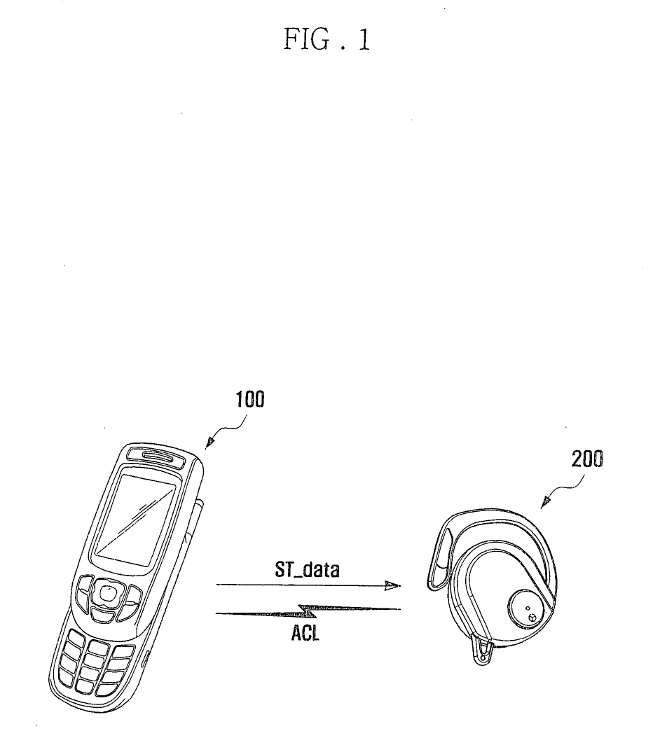

FIG. 1 is a schematic diagram illustrating a multi-type audio processing system according to an exemplary embodiment of the present invention.

In FIG. 1, the multi-type audio processing system includes a mobile phone 100 and a headset 200 connected with each through a short range wireless communication channel, i.e. a Bluetooth channel. etc.

In a pairing process, the headset 200 transmits an Advanced Audio Distribution Profile (A2DP) or a mode selection signal to the mobile phone 100, such that the mobile phone 100 recognizes that the headset 200 supports a stereo audio file.

Accordingly, the mobile phone 100 can transmit stereo audio (ST_data) to the headset 200 through an asynchronous connectionless (ACL) channel established between the mobile phone 100 and the headset 200 in accordance with protocols and procedures defined by the A2DP.

In the pairing process, the headset 200 transmits the A2DP or mode selection signal to the mobile phone 100, the mobile phone 100 establishes an ACL channel with the headset 200 and transmits stereo audio to the headset 200. The mode selection signal carries a mode indication parameter for requesting an audio mode. The audio mode is classified into categories including but not limited to a stereo mode, a mono mode, and a normal mode for voice.

The stereo mode can be sub-classified into a per-channel play mode in which the stereo audio is decoded into several audio channels and each audio channel is played individually, and a mixed play mode in which the audio channels are mixed by mixing group and each mixing group is played individually. That is, the stereo mode can be classified into a left channel output mode for outputting only the left channel through the left earpiece of the headset 200, a right channel output mode for outputting only the right channel through the right earpiece of the headset 200, and a mixing mode for outputting both the left and right channels of the stereo audio through the left and right channels. The headset 200 processes the stereo audio (ST_data) in accordance with one of the audio processing modes.

Typically, the normal mode is a default mode for exchanging mono audio stream (MN_data), i.e. voice data generated in a voice communication session.

The headset 200 processes and outputs the left channel audio through the left earpiece in the left channel output mode, and processes and outputs the right channel audio through the right earpiece.

In the left or right channel output mode, the headset 200 processes and outputs a main audio channel such as base channel or soprano channel from the stereo audio through one of the left and right earpieces. In the mixing mode, the headset 200 mixes the left and right channel audio data and then output the mixed audio data through both the left and right earpieces.

The mobile phone 100 establishes a Synchronous Connection Oriented (SCO) channel when a voice communication session is established, so as to exchange voice data with the headset 200 through the SCO channel.

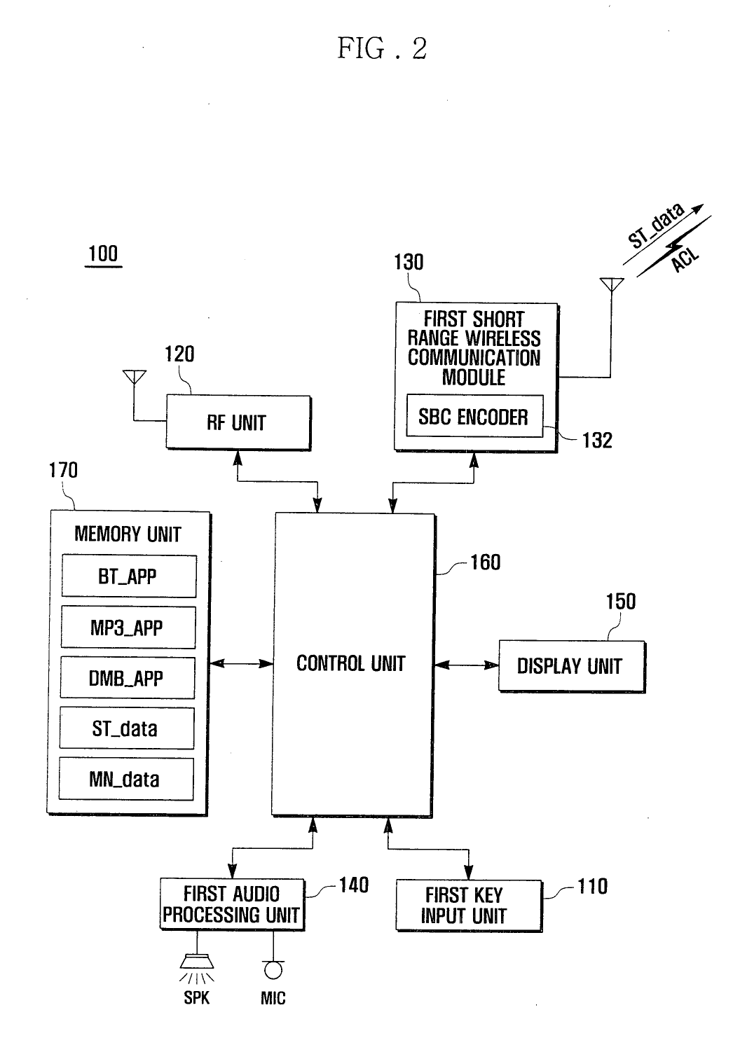

FIG. 2 is a block diagram illustrating a configuration of the mobile phone 100 of FIG. 1.

Referring to FIG. 2, the mobile phone 100 includes a first short range wireless communication module 130, a memory unit 170, a first key input unit 110, a display unit 150, a first audio processing unit 140, a radio frequency (RF) unit 120, and a control unit 160.

The short range wireless communication module 130 can be implemented on the basis of a short range wireless communication standard such a Bluetooth, ZigBee, UWB, or IrDA. In this exemplary embodiment, Bluetooth is adopted for the short range wireless communication module 130 in consideration of popularity. In the case of using a Bluetooth module as the short range wireless communication module 130, a Sub Banding Coding (SBC) encoder 132 is integrated within the short range wireless communication module 130. The SBC encoder 132 can encode the stereo audio (ST_data) as well as mono audio (MN_data).

With regard to the short range wireless communication module 130, according to an exemplary embodiment of the present invention, Bluetooth operates in the unlicensed Industrial Scientific Medical (ISM) band at 2.4 Gigahertz using 79 channels between 2.402 GHz to 2.480 GHz (23 channels in some countries). The range for Bluetooth communication is up to 10 meters with a power consumption of 0 dBm (1 mW). This distance can be increased to 100 meters by amplifying the power to 20 dBm. The Bluetooth radio system is optimized for mobility. Bluetooth operates with very low power, as little as 0.3 mA in standby mode and 30 mA during sustained data transmissions. Bluetooth uses a fast frequency hopping spread spectrum (FHSS) technique for avoiding interference. With 78, 1 MHz channels, Bluetooth provides a lower guard band of 2 MHz and an upper guard band of 3.5 MHz.

Bluetooth is classified into three classes by transmit power: class 1 up to 100 mW, class 2 up to 2.4 mW, and class 3 up to 1 mW. Also Bluetooth uses Gaussian Frequency Shift Keying (GFSK) and supports 3 SCO channels with A-Law, u-Law PCM, and Continuous Variable Slope Delta Modulation (CVSD).

With regard to the short range wireless communication unit, ZigBee, which may also be used, is intended for use in embedded applications requiring low data rates and low power consumption, especially for home automation such as light and climate control, control of doors and window shutters, security and surveillance systems, etc. ZigBee is IEEE 802.15.4 standard for wireless personal area networks and is characterized by dual PHY of 2.4 GHz and 868/915 MHz, Direct Sequence Spread Spectrum (DS-SS), and data rate of 20˜25 kbps.

Still referring to FIG. 2, the memory unit 170 stores various application programs such as Bluetooth application (BT_App), MPEG audio Layer-3 (MP3) application (MP3_App), DMB application (DMB_App), voice communication application, etc. The memory unit 170 may be divided into a program region and data region.

The program region stores an operating system (OS) for booting and managing the mobile phone 100 and a plurality of application programs for performing supplementary functions such as camera, MP3, DMB, Bluetooth, and voice and data communication. The mobile phone 100 activates the supplementary functions in accordance with user command. The Bluetooth application manages to establish the ACL channel or SCO channel between the mobile phone 100 and the headset 200 in accordance with the communication mode of the headset 200. The Bluetooth channel is established on the basis of the headset profile transmitted by the headset 200.

The data region stores application and user data such as audio file played with MP3 function and video files played with motion picture play function. According to an exemplary aspect of the present invention, the audio file can be transmitted through different channels according to the audio mode of the headset 200. That is, when the headset 200 operates in a stereo mode, the audio file is transmitted through an ACL channel. When the headset 200 operates in the mono mode or normal mode, the audio file or voice signal is transmitted through the SCO channel. The data region can store both the stereo audio (A2DP) files and mono audio files.

The first key input unit 110 includes a plurality of alphanumeric keys and function keys for receiving user input and activating various functions. The function keys include navigation keys for navigating cursor over menu options, side keys, and shortcut keys. The first key input unit 110 generates a key signal input by the user and transfers the key signal to the controller 160.

Particularly, the first key input unit 110 is implemented so as to deliver key signals associated with audio playback control, such as “play”, “pause”, “fast forward”, and “rewind”, to the controller 160.

The display unit 150 displays the information input by the user or provided by the mobile phone.

Particularly, the display 150 displays a menu screen associated with the audio playback function and communication status between the mobile phone 100 and the headset 200. The display unit 150 also presents a status of the headset 200.

The first audio processing unit 140 processes the audio stream including voice in communication mode, MP3 audio, and DMB audio.

Particularly, when the headset 200 is not connected, the first audio processing unit 140 processes the audio stream and outputs the processed audio stream through an internal speaker (SPK) in the form of audible sound wave. On the other hand, when the headset 200 is connected, the first audio processing unit 140 is disabled because by design it is presumed that a user would not connect a headset and desire sound from the audio processing unit, while the audio stream is transmitted to the headset 200 through the wireless channel established between the mobile phone 100 and the headset 200.

The RF unit 120 is responsible for transmitting and receiving radio signals to/from the control unit 160 in particular. The RF unit 120 includes an RF transmitter for up-converting a baseband signal into an RF signal and amplifying the RF signal for transmission, and an RF receiver for low noise amplifying an RF signal received through an antenna and down-converting the RF signal into a baseband signal.

Particularly, the RF unit 120 is implemented so as to receive and process the cellular radio signals and DMB broadcast signals. Typically, MP3 files downloaded through a cellular system and the DMB program received from a broadcast center are provided in a stereo audio format, i.e. A2DP format.

The controller 160 controls general operations of the mobile phone 100 and cooperation of the internal components. The controller 160 can incorporate, for example, modem and codec functions.

In the case of transmitting audio stream (ST_data) to the headset 200, the controller 160 controls the first short range wireless communication module 130 and executes the Bluetooth application to establish an ACL channel between the mobile phone 100 and the headset 200 such that the audio data stored in the memory unit 170 or an external storage are transmitted to the headset 200 through the ACL channel.

According to an exemplary aspect of the present invention, in order for the mobile phone 100 to transmit the mono audio stream (MN_data) or voice stream, the controller 160 controls the first short range wireless communication module 130 to establish an SCO channel between the mobile phone 100 and the headset 200.

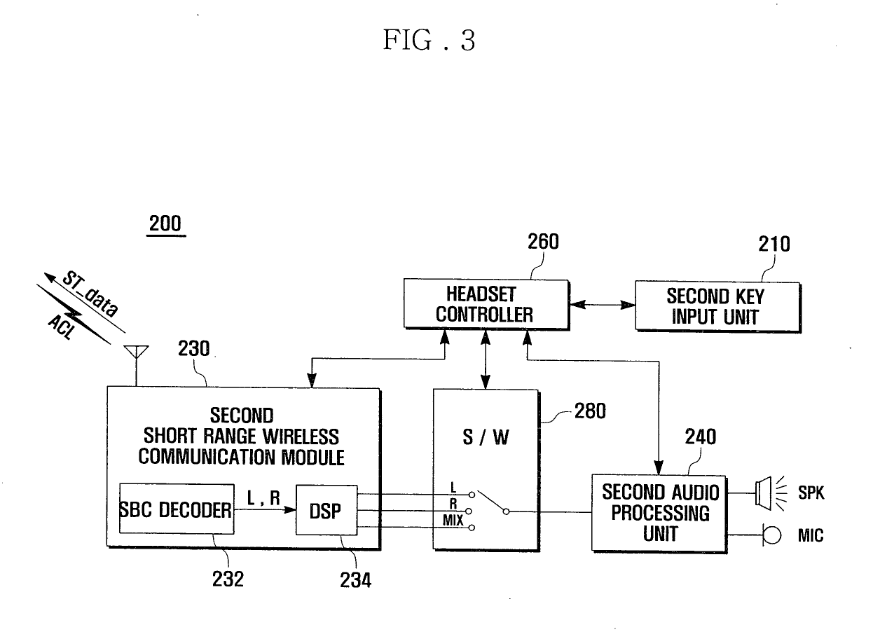

FIG. 3 is a block diagram illustrating a configuration of the headset 200 of FIG. 1. The headset 200 decodes the stereo audio stream (ST_data) received from the mobile terminal through a Bluetooth channel by channel and outputs the decoded channel audio streams through respective earpieces of the headset 200.

Referring to FIG. 3, the headset 200 includes a second short range wireless communication module 230, a second key input unit 210, a second audio processing unit 240, a switch 280, and a headset controller 260.

The second short range wireless communication module 230 comprises, for example, a Bluetooth module (or a ZigBee module) identical with the first short range wireless communication module 130 of the mobile phone 100. The second short range wireless communication module 230 can establish an ad hoc network, i.e. a piconet, with other Bluetooth devices including the mobile phone 100 such that the headset 200 can receive control and data signal through a Bluetooth channel established between the first and second short range wireless communication units 130 and 230.

Still referring to FIG. 3, in this exemplary embodiment, the first and second short range wireless communication modules 130 and 230 are implemented with the Bluetooth modules such that the second short range wireless communication module 230 include SBC decoder 232. The SBC decoder 232 decodes the stereo audio stream encoded by the SBC encoder 132 of the mobile phone 100 and outputs the stereo audio stream (ST_data) in the form of left channel audio stream (L) and right channel audio stream (R). The second short range wireless communication module 230 includes a digital signal processor (DSP) 234 for mixing the left and right channel audio streams output from the SBC decoder 232. The DSP 234 outputs the left channel audio stream (L) and right channel audio stream (R) and mixed audio stream (MIX) through different output ports, and the switch 280 selectively delivers the left and right channel audio streams L and R and the mixed audio stream (MIX) to the second audio processing unit 240. When the audio stream decoded by the SBC decoder 232 is a mono audio stream (MN_data) or a voice audio stream, the DSP 234 bypasses the audio stream to the switch 280.

The headset 200 can be implemented such that the DSP directly transfers one of the left and right audio stream or the mixed audio stream to the second audio processing unit 240. In this case, the switch 280 can be deleted.

As shown in the example in FIG. 3, the second key input unit 210 generates key signals associated with an audio transmission request, an incoming call acceptance request, and an audio playback control signals in response to a user input, and accordingly transmits the key signals to the mobile phone 100 through the short range wireless communication channel. Particularly, the second key input unit 210 generates key signals for activating an audio output mode, i.e. normal mode, left channel output mode, right channel output mode, and mixing mode in response to the user input, and transfers the key signals to the headset controller 260. The second key input unit 210 also generates key signals for adjusting the audio volume of the headset 200.

The second audio processing unit 240 processes the left audio stream (L), a right audio stream (R), a mixed audio stream (MIX) originated from the voice, a mono audio stream (ST_data), a stereo audio stream (ST_data), and an output the audio streams through the speaker (SPK) in the form of audible sound wave. The second audio processing unit 240 is connected to a microphone (MIC) for receiving user voice in a voice communication session.

The switch 280, as shown in the example shown in FIG. 3, is interposed between the DSP 234 and the second audio processing unit 240, so as to selectively output the left audio stream (L), right audio stream (R), and mixed audio stream (MIX) from the DSP 234 to the second audio processing unit 240 in response to the key signal input through the second key input unit 210. In other words, the switch 280 switches between the left and right audio streams and the mixed audio stream output from the DSP 234 and delivers the audio stream to the second audio processing unit 240.

The headset controller 260 controls to provide the mobile phone 100 with information on the communication profile supported by the headset 200, establishes an ACL channel, receives the stereo audio stream (ST_data) through the ACL channel, and decodes and selectively outputs the decoded audio data. The headset controller 260 controls to establish an SCO channel with the mobile phone 100 for receiving the mono audio stream (MN_data) in accordance with the mode selection signal input through the second key input unit 210.

In a case where a voice communication mode is requested by the mobile phone 100, the headset controller 260 also controls the establishment of the SCO channel with the mobile phone 100 for exchanging voice data. In this case, the headset controller 260 can provide controls to establish the ACL channel, rather than SCO channel, for exchanging voice data and communication control signals.

In Particular, when the mobile phone 100 transmits the SBC encoded stereo audio stream (ST_data), the headset controller 260 controls the SBC decoder 232 to decode the SBC encoded stereo audio stream (ST_data) and controls the DSP 234 to mix the SBC decoded audio streams to output the mixed audio stream (MIX). The headset controller 260 typically controls the switch 280 to selectively deliver the left audio stream (L), right audio stream (R), or a mixed audio stream (MIX) to the second audio processing unit 240.

In the above exemplary embodiment, the multi-type audio processing system is described with the block diagrams as in FIGS. 1 to 3 in order to simplify the explanation. However, the present invention is not limited to the arrangement of block diagrams as shown. For example, the mobile phone can integrate a camera and multimedia processing module, and the headset can integrate a display unit and an external battery, which can be contactlessly charged. The integration of the display unit and the headset is not limited to any particular type of power use. An audio processing operation of the above-structured multi-type audio processing system is described hereinafter.

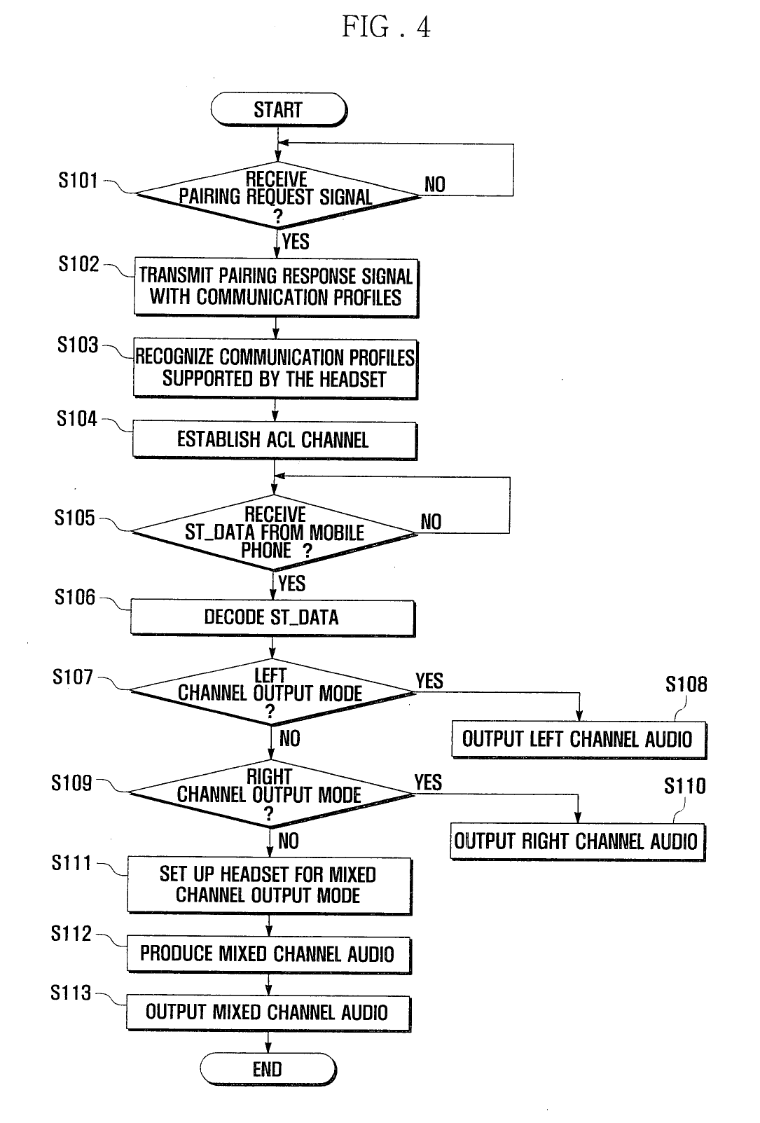

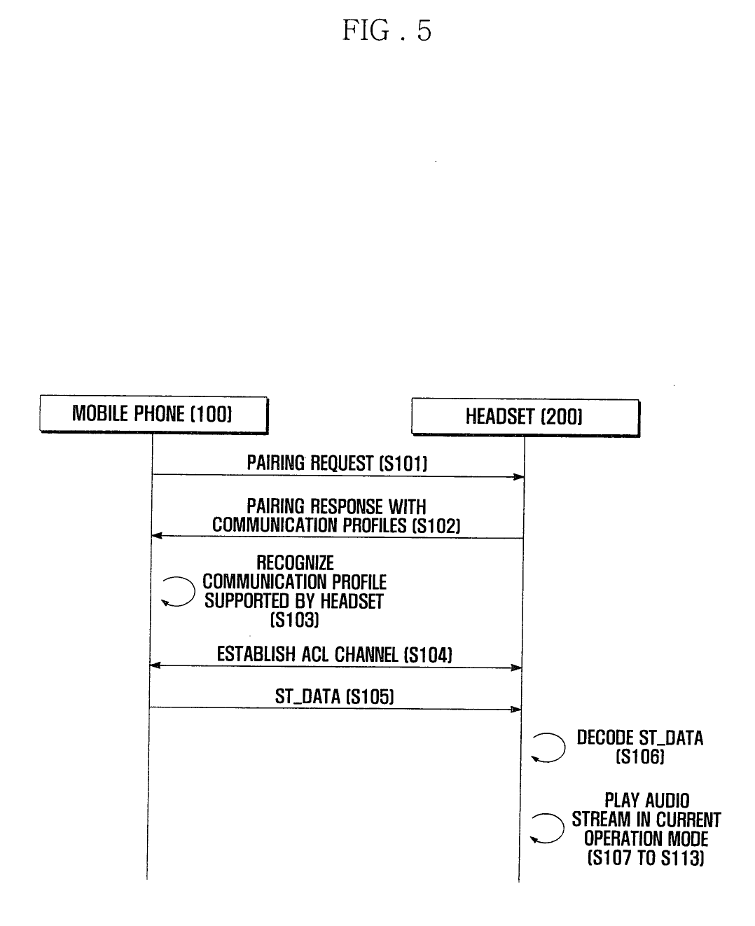

FIG. 4 is a flowchart illustrating the steps of a multi-type audio processing method according to an exemplary embodiment of the present invention, and FIG. 5 is a message flow diagram illustrating the multi-type audio processing method of FIG. 4.

In this exemplary embodiment, the multi-type audio processing method is described with Bluetooth as a short range wireless communication standard for implementing the multi-type audio processing system, but other systems can be used. The stereo and mono audio represents all kinds of music such as pop songs and instrumental sounds, voice data such as recorded lectures and speeches, sound tracks from movies, which include voice and music, and natural sounds. Also, the audio streams to be output through left and right earpieces of the headset are called left and right channel audio streams, respectively. In this exemplary embodiment, the operation mode of the headset is classified into a left channel output mode for outputting a left channel audio stream and a right channel output mode for outputting a right channel audio stream. The left and right channel audio streams are distinguished from each other by the frequency bands in the stereo audio stream.

Referring to FIGS. 4 and 5, the headset 200 typical monitors/detects whether a pairing request signal has been received from the mobile phone 100 (S101), and the headset 200 transmits a pairing response signal to the mobile phone 100 together with Bluetooth profiles supported by the headset 200 (S102). If the pairing response signal is received, the mobile phone 100 recognizes that the headset 200 supports audio processing on the basis of the Bluetooth profiles (S103), and establishes an ACL channel with the headset 200 (S104). Next, the mobile phone 100 activates an audio playback application, for example, an MP3 player application, in response to a key signal input through the key input unit or received from the headset, and plays a source file such that the source file is transmitted to the headset 200 in the form of a stereo audio stream (ST_data). The stereo audio stream can be SBC-encoded before transmitted before transmitted to the headset 200.

Still referring to the flowchart in FIG. 4, at (S105) the headset 200 determines whether a stereo audio stream (ST_data) is received from the mobile phone 100 through the ACL channel (S105). If a stereo audio stream is received, the headset 200 decodes the stereo audio stream (ST_data), for example, performs SBC decoding (S106). The headset controller controls to the delivery of one of the left channel audio stream, right channel audio stream, and mixed audio stream to the second audio processing unit 240 in accordance with a mode selection signal input through the second key input unit 210.

For example, the headset controller 260 determines whether the headset 200 is set up for the left channel output mode (S107) and controls, if the headset 200 is set up for the left channel output mode, the switch 280 delivers the left channel audio stream such that the left channel audio stream is processed to be output through the left earpiece of the headset 200 (S108).

However, if the headset 200 is not set up for the left channel output mode, the headset controller 260 determines whether the headset 200 is set up for the right channel output mode (S109). If the headset 200 is set up for the right channel output mode, the headset controller 260 controls the switch 280 to deliver the right channel audio stream such that the right channel audio stream is processed to be output through the right earpiece of the headset 200 (S110).

If the headset 200 is not set up for the right channel output mode, the headset controller 260 sets up the headset 200 for the mixed channel output mode (S111) and controls the DSP 234 to mix the left and right channel audio stream to produce a mixed channel audio (S112). Next, the headset controller 260 controls the switch 280 to deliver the mixed audio stream to the second audio processing unit 240 such that the mixed audio stream is processed to be output through both the left and right earpieces of the headset 200 (S113).

As described above, the multi-type audio processing method according to an exemplary embodiment of the present invention, in accordance with the flowchart shown in FIG. 4, encodes and transmits the stereo audio stream on the basis of the Bluetooth profiles supported by the headset. The headset 200 decodes the received stereo audio stream based on the coding scheme for the system and processes the decoded audio streams in a channel output mode selected by the user, resulting in mode adaptive audio output.

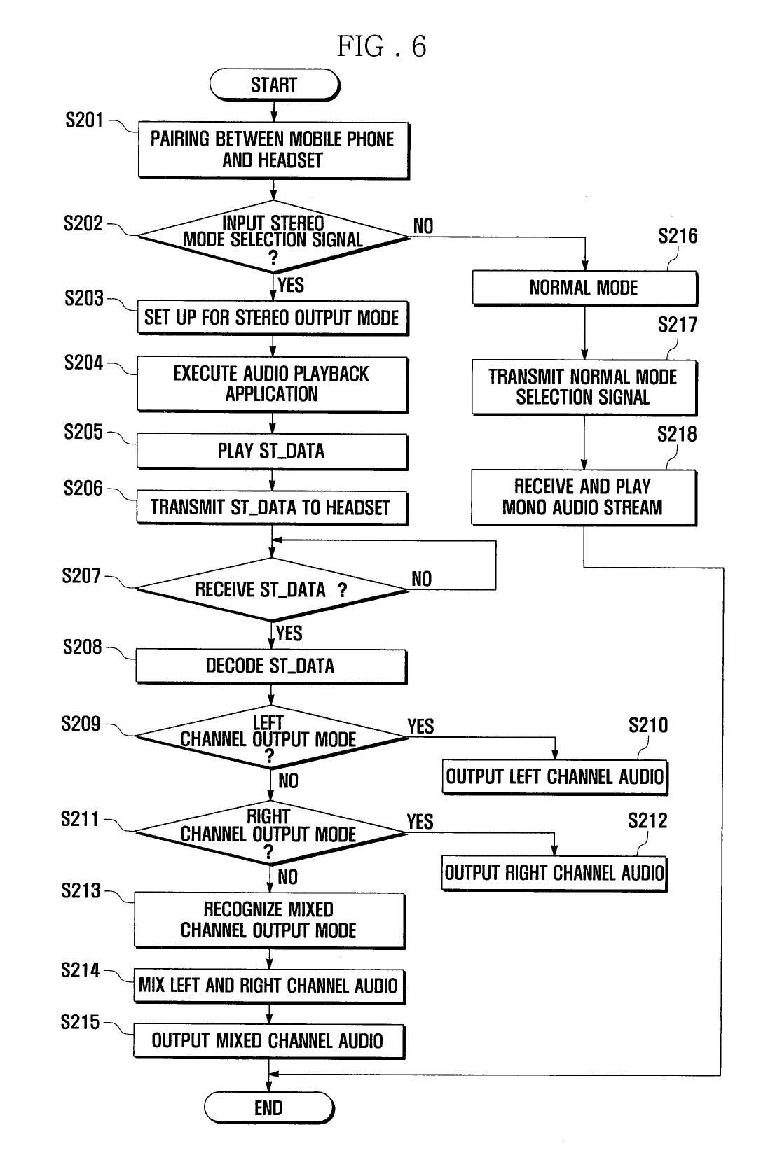

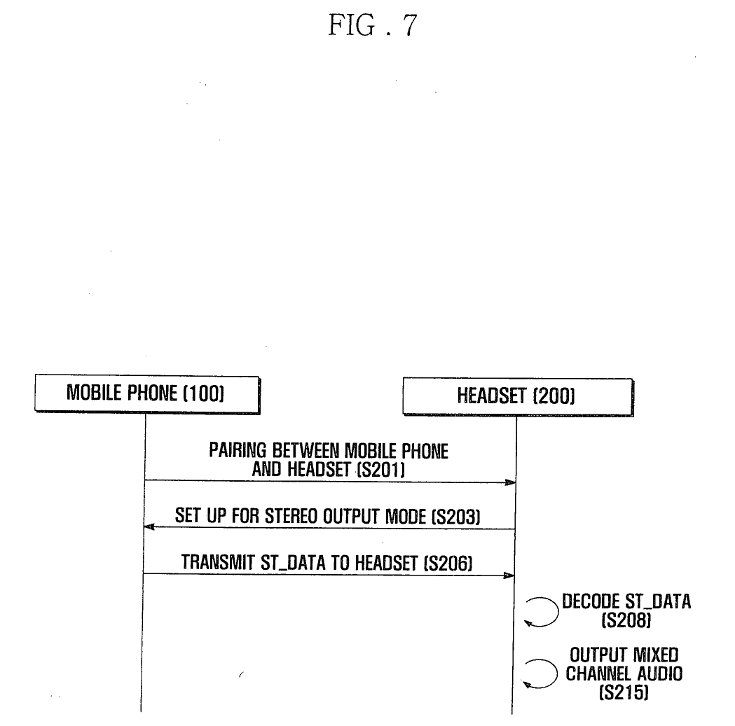

FIG. 6 is a flowchart illustrating the steps of a multi-type audio processing method according to another exemplary embodiment of the present invention, and FIG. 7 is a message flow diagram illustrating the multi-type audio processing method as exemplified in FIG. 6.

In this exemplary embodiment, the headset 200 operates in a stereo output mode or a normal output mode. The stereo output mode is classified into left channel output mode, right channel output mode, and mixed channel output mode. The normal output mode is an operation mode for processing the mono audio stream or voice stream. The headset controller 260 generates a mode selection signal and transmits the mode selection signal to the mobile phone 100, in response to a user command input through the second key input unit 210. The mode selection signal includes a stereo mode selection signal and a normal mode selection signal. The second key input unit 210 is configured to match the operation mode of the headset 200, i.e. the stereo output mode or normal output mode.

The stereo audio stream consists of left and right channel audio streams, in which each stream is defined by a group of frequency bands, such that the left channel audio stream is output through the left earpiece of the headset 200 and the right channel audio stream is output through the right earpiece of the headset 200. The frequency bands constituting the left and right channel audio streams can be separately arranged or partially overlapped with each other.

Referring to FIGS. 6 and 7, in the multi-type audio processing method, the mobile phone 100 and the headset 200 are paired through a pairing process (S201). After the mobile phone 100 and the headset 200 are paired, the headset controller 260 detects a key input signal and determines whether the key input signal is a stereo mode selection signal for configuring the headset 200 to process the stereo audio stream (S202). If a stereo mode selection signal is input, the headset controller then 260 sets up the headset 200 for the stereo output mode and transmits the stereo mode selection signal to the mobile phone 100 (S203).

The stereo output mode can be one of the left channel output mode, right channel output mode, and mixed channel output mode. Accordingly, the stereo mode selection signal that is transmitted to the mobile phone 100 carries a stereo mode parameter for indicating a sub-stereo output mode, i.e. the left channel output mode, right channel output mode, and mixed channel output mode.

If the stereo mode selection signal is received, the mobile phone 100 executes an audio playback application, for example an MP3 player application (S204), and plays a stereo audio file and outputs the stereo audio file in the form of the stereo audio stream (ST_data) (S205). Next, the mobile phone 100 transmits the stereo audio stream (ST_data) to the headset 200 through a Bluetooth channel established between the mobile phone 100 and the headset 200 (S206). Preferably, the stereo audio stream can be encoded in an SBC coding scheme before transmission, and the Bluetooth channel is an ACL channel.

Meanwhile, the headset controller 260 of the headset 200 monitors the ACL channel and determines whether a stereo audio stream is received from the mobile phone 100 (S207) and decodes, if a stereo audio stream is received, the stereo audio stream (ST_data) (S208). Next, the headset controller 260 checks the currently configured operation mode and determines whether the current operation mode is the left channel output mode (S209). If the current operation mode is the left channel output mode, the headset controller 260 controls the switch 280 to switch on the left channel audio stream of the decoded stereo audio stream to the second audio processing unit 240 such that the left channel audio stream is output through the left earpiece of the headset 200 (S210). If the current operation mode is not the left channel output mode, the headset controller 260 determines whether the current operation mode is the right channel output mode (S211). If the current operation mode is the right channel output mode, the headset controller 260 controls the switch 280 to switch on the right channel audio stream of the decoded stereo audio stream such that the right channel audio stream is output through the right earpiece of the headset 200 (S212). If the current operation mode is not the right channel output mode, the headset controller 260 determines that the current operation mode is the mixed channel output mode (S213) and controls the DSP 234 to mix the left and right channel audio streams (S214), and controls the switch 280 to switch on the mixed channel audio stream such that the mixed channel audio stream is output through both the left and right earpieces of the headset (S215). It should be understood that it is within the spirit and the scope of the invention, and particularly this exemplary embodiment, that when the examples state that the headset controller 250 checks for left channel mode, the headset controller could also check for right channel mode first, followed by the left. In general there is no requirement that a specific sequence be literally followed as described.

Returning to step S202, if the key input signal is not a stereo mode selection signal, the headset controller 260 determines that the key input signal is the normal mode selection signal for configuring the headset 200 to process the mono audio stream (S216) and transmits the normal mode selection signal to the mobile phone 100 (S217). Next, the headset controller 260 receives and processes the mono audio stream (MN_data) from the mobile phone 100 such that the mono audio stream is output through one of the left and right earpieces of the headset 200 (S218). It is also within the spirit and scope of the invention that the mono audio stream could be output to both the left and right earpieces, as there is a tendency for users to hear something more accurately/better when the sound is delivered to both ears, not just one, as ambient noise heard by a user's ear that does not receive the signal can degrade the ability of the user to process the sound received by the other ear.

As described above, the multi-type audio processing system and method of the present invention can enable a headset to processes stereo and mono audio streams transmitted by a mobile phone in various output modes, whereby the headset can provide audio sound adaptive user preference or ambient environment.

Also, the multi-type audio processing system and method of the present invention can enable a headset to operate in a stereo audio output mode even in a voice communication session, whereby it is possible to output a voice stream together with other stereo audio stream.

Although exemplary embodiments of the present invention are described in detail hereinabove, it should be clearly understood that many variations and/or modifications of the basic inventive concepts herein taught which may appear to those skilled in the present art will still fall within the spirit and scope of the present invention, as defined in the appended claims.

As described above, the multi-type audio processing system and method of the present invention are advantageous in that a signal headset can process both stereo and mono audio streams.

What is claimed is:

1. A multi-type audio processing method for an audio system including an audio source device and a headset connected to the audio source device, comprising:
transmitting by the headset, capability information of the headset to the audio source device;
transmitting, by the audio source device, an audio stream to the headset on the basis of the capability information received from the headset; and
playing at the headset, the audio stream received from the audio source device.

2. The multi-type audio processing method according to claim 1, wherein the audio stream is one of a stereo audio stream and a mono audio stream.

3. The multi-type audio processing method according to claim 1, wherein the capability transmitted by the headset is determined by a key input signal identifying a requested mode selection of transmission by the audio source device.

4. The multi-type audio processing method of claim 1, further comprising:
pairing the audio source device and the headset;
establishing an asynchronous connection oriented channel between the audio source device and the headset after the audio source device and the headset being paired; and
encoding the stereo audio stream before transmission.

5. The multi-type audio processing method of claim 1, wherein playing the stereo audio stream comprises:
decoding the stereo audio stream to output at least one audio channel;
selecting one of the audio channels as an output audio channel; and
outputting the output audio channel.

6. The multi-type audio processing method of claim 5, wherein selecting one of the audio channels as an output audio channel comprises:
checking an operation mode of the headset; and
selecting an audio channel associated with the operation mode as the output audio channel.

7. The multi-type audio processing method of claim 6, wherein the operation mode comprises a mixing mode in which a mixed channel produced by mixing the audio channels is selected as the output audio channel.

8. The multi-type audio processing method of claim 1, wherein playing the stereo audio stream comprises:
decoding the stereo audio stream to output a left and right audio channels;
mixing the left and right audio channels to output a mixed audio channel;
selecting one of the audio channels in response to an input command; and
playing the selected audio channel.

9. A multi-type audio processing method for an audio system including a mobile phone and a headset connected to the mobile phone, comprising:
transmitting by the headset, a mode selection signal informing a current operation mode of the headset to the mobile phone;
transmitting by the mobile phone, an audio file supported by the operation mode; and
playing by at the headset, the audio file received from the mobile phone.

10. The multi-type audio processing method of claim 9, wherein the operation mode comprises:
a stereo mode for playing a stereo audio file; and
a mono mode for playing a mono audio file and voice stream received in voice communication session of the mobile phone.

11. The multi-type audio processing method of claim 10, wherein the stereo mode comprises:
a per-channel output mode for outputting one of audio channels constituting the stereo audio file; and
a mixed channel output mode for mixing at least two of the audio channels and outputting a mixed audio channel.

12. The multi-type audio processing method of claim 11, wherein the per-channel output mode comprises:
a left channel output mode for outputting a left channel audio of the audio channels; and
a right channel output mode for outputting a right channel audio of the audio channels.

13. The multi-type audio processing method of claim 12, wherein the mixed audio channel is produced by mixing the left and right channel audios.

14. The multi-type audio processing method of claim 11, wherein the mobile phone and the headset are connected through an asynchronous connectionless channel.

15. The multi-type audio processing method of claim 11, wherein the mobile phone and the headset are connected through a synchronous connection oriented channel.

16. A multi-type audio processing system comprising:
a mobile phone for generating an audio stream from an audio source and transmitting an audio stream; and
a headset for playing the audio stream received from the mobile phone, the headset being connected with the mobile phone through a short range wireless communication channel,
wherein the headset transmits a communication profile supported by the headset and a mode selection signal for indicating an operation mode of the headset to the mobile phone, the mobile phone transmits the audio stream in accordance with the communication profile and the mode selection signal, and then the headset decodes the received audio stream and playing on the basis of the operation mode.

17. The multi-type audio processing system of claim 16, wherein the mobile phone comprises:
a first short range wireless communication module for establishing the short range wireless communication channel with the headset;
a controller for controlling transmission of the audio stream;
a memory for storing the audio file; and
a first key input unit for receiving a key input for playing the audio file.

18. The multi-type audio processing system of claim 17, wherein the headset comprises:
a second key input unit for receiving a key input for generating the mode selection signal;
a second short range wireless communication module for establishing the short range wireless communication channel with the mobile phone;
a headset controller for controlling to process the audio stream on the basis of the operation mode; and
an audio processing unit for processing the audio stream under the control of the controller.

19. The multi-type audio processing system of claim 18, wherein the operation mode comprises:
a stereo mode for processing a stereo audio stream; and
a mono mode for processing a mono audio stream and voice stream received in voice communication session of the mobile phone.

20. The multi-type audio processing system of claim 19, wherein the stereo mode comprises:
a per-channel output mode for outputting one of audio channels constituting the stereo audio stream; and
a mixed channel output mode for mixing at least two of the audio channels and outputting a mixed audio channel.

21. The multi-type audio processing system of claim 20, wherein the per-channel output mode comprises:
a left channel output mode for outputting a left channel audio of the audio channels; and
a right channel output mode for outputting a right channel audio of the audio channels.

22. The multi-type audio processing system of claim 21, wherein the mixed audio channel is produced by mixing the left and right channel audios.
